(19) United States
(12) Patent Application Publication
(10) Pub. No.: US 2020/0403454 A1
(43) Pub. Date: Dec. 24, 2020

(54) WIRELESS CHARGING METHOD, DEVICE, TERMINAL, STORAGE MEDIUM, AND ELECTRONIC DEVICE

(71) Applicant: ZTE CORPORATION, Shenzhen (CN)

(72) Inventors: Tao CHEN, Shenzhen (CN); Shiwei LIU, Shenzhen (CN)

(21) Appl. No.: 16/769,977

(22) PCT Filed: Oct. 8, 2018
(86) PCT No.: PCT/CN2018/109299

§ 371 Date: Jun. 4, 2020

(30) Foreign Application Priority Data
Dec. 7, 2017 (CN) 201711288251.4

(51) Int. Cl. H02J 50/80; H02J 7/34; H02J 7/00; H02J 50/12

(52) U.S. Cl. CPC H02J 50/80; H02J 50/12; H02J 7/00045; H02J 7/345

(57) ABSTRACT

Provided are a wireless charging method and device, a terminal, a storage medium and an electronic device. The method includes determining the charging type of a wireless charger connected to the terminal; adjusting the charging mode of the terminal to a charging mode matching the charging type of the wireless charger; and charging the terminal by using the wireless charger. The following problem is solved: charging fails due to a single charging mode and the mismatch between the charging type of a charger and the charging mode of a terminal in the related art. The following purpose is achieved: a terminal has more charging modes and thus the terminal can be charged regardless of the charging type of a charger used.

### TECHNICAL FIELD

The present disclosure relates to the field of wireless charging and, in particular, to a wireless charging method and device, a terminal, a storage medium and an electronic device.

### BACKGROUND

With the development of science and technology, as a consumer electronic accessory, wireless charging has successfully won the favor of consumers. However, in the case where this technology has been widely adopted and has become the mainstream in the market, this technology has not reached the expected level.

Because wireless charging has been relatively widely adopted, multiple terminals produced by terminal manufacturers can support wireless charging. The current standards of wireless charging mainly include the Qi standard, the Power Matters Alliance (PMA) standard and the Alliance for Wireless Power (A4WP) standard. Currently, there are wireless chargers and wirelessly chargeable terminals supporting Qi and/or PMA (hereinafter referred to as Qi/PMA) in the market and there are also wireless chargers and wirelessly chargeable terminals supporting A4WP. However, wireless charging can be achieved only when the charging type of a charger completely matches the charging mode of a terminal. As a result, some problems occur, for example, a charger whose charging type is Qi/PMA cannot be used to charge a terminal whose charging mode is A4WP and a charger whose charging type is A4WP cannot be used to charge a terminal whose charging mode is Qi/PMA. Moreover, after a terminal is got, it is not easy to identify which charging mode the terminal supports. If a mismatched charger is used to charge the terminal, charging cannot be performed and the charger may even be damaged.

No effective solution has been proposed yet to solve the problem of charging failure caused by a single charging mode and the mismatch between the charging type of a charger and the charging mode of a terminal in the related art.

### SUMMARY

Embodiments of the present disclosure provide a wireless charging method and device, a terminal, a storage medium and an electronic device so that at least the problem of charging failure caused by a single charging mode and the mismatch between the charging type of a charger and the charging mode of a terminal in the related art is solved.

According to an embodiment of the present disclosure, a wireless charging method is provided. The wireless charging method includes determining the charging type of a wireless charger connected to the terminal; adjusting the charging mode of the terminal to a charging mode matching the charging type of the wireless charger; and charging the terminal by using the wireless charger.

According to another embodiment of the present disclosure, a wireless charging device is further provided. The wireless charging device includes a determination module, an adjustment module and a first charging module. The determination module is configured to determine the charging type of a wireless charger connected to the terminal. The adjustment module is configured to adjust the charging mode of the terminal to a charging mode matching the charging type of the wireless charger. The first charging module is configured to charge the terminal by using the wireless charger.

According to another embodiment of the present disclosure, a wirelessly chargeable terminal is further provided. The wirelessly chargeable terminal includes an A4WP communication system and a controller. The A4WP communication system is configured to determine the charging type of a wireless charger. The controller is connected to the A4WP communication system and is configured to adjust, according to the charging type of the wireless charger, the charging mode of the terminal to a charging mode matching the charging type of the wireless charger.

According to another embodiment of the present disclosure, a storage medium is further provided. The storage medium includes a stored program. The steps in any one of the method embodiments described above are performed when the program is executed.

According to another embodiment of the present disclosure, an electronic device is further provided. The electronic device includes a memory, a processor and a computer program stored in the memory and executable on the processor, where the processor is configured to perform the steps in any one of the method embodiments described above through the computer programs.

In embodiments of the present disclosure, the charging mode of a terminal can be adjusted according to the charging type of a wireless charger so that the purpose of charging a terminal no matter what type of wireless charger is adopted is achieved. In this manner, the following problem is solved: charging fails due to a single charging mode and the mismatch between the charging type of a charger and the charging mode of a terminal in the related art; and thereby the following purpose is achieved: a terminal has more charging modes and thus the terminal can be charged regardless of the charging type of a charger used.

### BRIEF DESCRIPTION OF DRAWINGS

The drawings described herein are used to provide a further understanding of the present disclosure and form a part of the present application. The illustrative embodiments and the description thereof in the present disclosure are used to explain the present disclosure and not to limit the present disclosure in an improper manner. In the drawings:

FIG. 1 is a schematic diagram illustrating distribution of electromagnetic induction and resonance magnetic field in the related art;

FIG. 2 is a block diagram illustrating the hardware structure of a mobile terminal for a wireless charging method according to an embodiment of the present disclosure;

FIG. 3 is a flowchart of a wireless charging method according to an embodiment of the present disclosure;

FIG. 4 is a block diagram illustrating the structure of a wireless charging device according to an embodiment of the present disclosure;

FIG. 5 is block diagram one illustrating the principle of a wirelessly chargeable terminal according to an embodiment of the present disclosure;

FIG. 6 is block diagram two illustrating the principle of a wirelessly chargeable terminal according to an embodiment of the present disclosure;

FIG. 7 is a two-in-one receiving coil according to an embodiment of the present disclosure;

FIG. 8 is separated receiving coils according to an embodiment of the present disclosure;

FIG. 9 is a schematic diagram illustrating direct frequency modulation according to an embodiment of the present disclosure;

FIG. 10 is a schematic diagram illustrating indirect frequency modulation according to an embodiment of the present disclosure;

FIG. 11 is a general flowchart of a wireless charging method according to an embodiment of the present disclosure;

FIG. 12 is a flowchart of Qi/PMA standard charging according to an embodiment of the present disclosure; and

FIG. 13 is a flowchart of A4WP standard charging according to an embodiment of the present disclosure.

### DETAILED DESCRIPTION

Hereinafter the present disclosure will be described in detail with reference to the drawings in conjunction with the embodiments. It is to be noted that if not in collision, the embodiments and features therein in the present application may be combined with each other.

It is to be noted that the terms “first”, “second” and the like in the description, claims and drawings of the present disclosure are used to distinguish between similar objects and are not necessarily used to describe a particular order or sequence.

For ease of understanding, the related art of the present disclosure will be explained first.

As a consumer electronic accessory, wireless charging has successfully won the favor of consumers. However, in the case where this technology has been widely adopted and has become the mainstream in the market, this technology has not reached the expected level. One of the main reasons for this situation is different standards and major operators supporting competing standards. Two possibilities are expected to emerge in the current standard environment.

The first possibility is that the emergence of a single standard may speed up the adoption of the wireless charging technology.

The second possibility is that a solution can support multi-mode wireless charging, where a single transmitter/receiver can support multiple (WPC/PMA/A4WP) standards.

The wireless charging technology has been relatively widely adopted and multiple types of mobile phones support this technology. Moreover, it is to be noted that wireless charging for some types of terminals has become a standard and supports Qi/PMA. However, the wireless charging frequency adopted by some newly released terminals is different from Qi so that the newly released terminals cannot be charged by ordinary Qi chargers and ordinary mobile phones supporting wireless charging cannot be charged by the standard wireless charger of the newly released terminals.

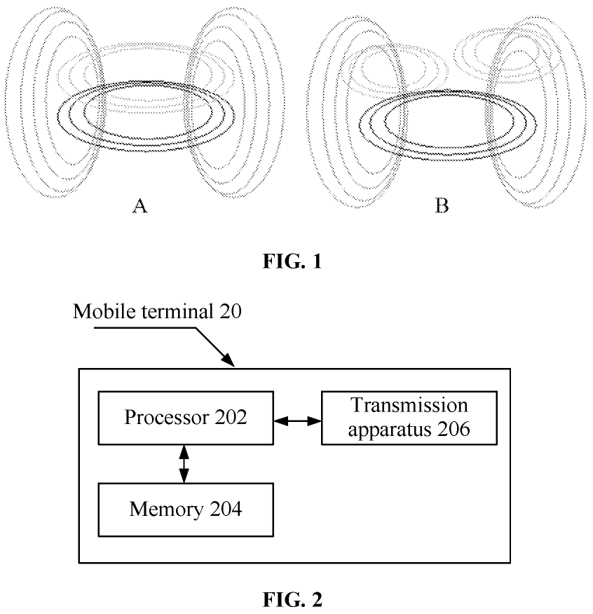

Compared with A4WP, Qi adopts a relatively small induction coil so that energy can be transmitted at a higher frequency easily as shown in A of FIG. 1. However, the disadvantage of Qi is also apparent, that is, the charging distance is relatively short and the maximum charging distance is only about 1 cm. Therefore, wireless charging device adopting Qi requires that devices such as mobile phones should be placed on the charging base, the center of a transmitting coil should be completely aligned with the center of a receiving coil, and a magnetic fixing apparatus should usually be provided. Another relatively big disadvantage of Qi is that multiple devices cannot be charged at the same time. Moreover, another criticized problem of Qi is that conductive materials inside devices such as mobile phones may be heated during charging and heat is caused.

To improve these disadvantages, someone proposed that multiple small coils are placed in a charging output apparatus so that the charging range is increased. However, the power consumption is undoubtedly increased and users still need to accurately place devices such as mobile phones in the area with an induced magnetic field to maintain a strong connection between devices and the charging base.

PMA is a standard competing with Qi, but also operates on the same principle of magnetic induction. Technically, these two standards are very similar.

In terms of improving the efficiency of energy transmission, the solution of A4WP is completely different from the solutions of Qi and PMA. Compared with Qi, A4WP adopts the principle of magnetic resonance, which does not require the primary coil to be closely aligned with the secondary coil. Conversely, the transmitting coil is large enough to generate a high magnetic field and can be engaged with the secondary coil close to the primary coil, and the number of the secondary coils is more than one as shown in B of FIG. 1. This means that a single transmitter can charge multiple receivers (such as phones, tablets). Meanwhile, because a precise resonance frequency is set, even a weak induced magnetic field can charge the device, which means that the charging range of A4WP is much larger than Qi. However, the principle of the magnetic resonance wireless charging technology adopted by A4WP is the same as the principle of the magnetic resonance wireless charging technology, which is essentially electromagnetic induction, but it is different in the way of using electromagnetic induction. Even though the principles are the same, the use effect of A4WP is completely different from the use effect of Qi. The charging range of A4WP is larger than that of Qi. In theory, charging through objects of A4WP can be achieved, and devices do not need to be accurately placed on the charging base.

For a multi-mode transmitter, it is a fairly complex task to combine a low-frequency transmitter and a high-frequency transmitter. In the case where a low-frequency coil is embedded into a high-frequency coil, some problems may occur in the system, such as a power supply coupling problem, a tuning challenge and coupling between MI and MR, which is why the design of multi-mode wireless transmitters stalls.

The condition for a series resonance circuit to generate resonance is shown in formula 1.

$$fr = \frac{1}{2 π \sqrt{LC}} \qquad ( 1 )$$

fr denotes a resonance frequency, L denotes a coil inductance, and C denotes a capacitance. For Qi/PMA wireless charging, in the case where L is fixed, according to an operating frequency of Qi of 100-205 KHz and an operating frequency of PMA of 277-357 KHz, the capacitance C is basically fixed. Currently, in the existing art, different capacitances Cs are used to achieve common-mode charging supporting two modes Qi/PMA under the same coil. However, A4WP is different. A4WP requires an accurate resonance frequency of 6.78 MHz, and a slight deviation in frequency may affect the charging efficiency. According to the formula 1, in the case where L of a coil is fixed, the capacitance C needs to be very small to generate the resonance frequency of 6.78 MHz. With the error of the capacitance, it becomes difficult to achieve complete resonance.

The design of a wireless charging multi-mode receiving end is a difficulty, especially if a receiving end supporting three modes A4WP/Qi/PMA is to be designed. During implementation, the wireless charging multi-mode receiving end may be achieved through a flexible printed circuit (FPC) with a small coil in a middle portion for magnetic induction and a large FPC in a peripheral portion for resonance.

The specific implementation of the existing common-mode wireless charging supporting both Qi and PMA is as follows: in the case where charging is performed in a Qi mode, an inner layer independent coil featured with a relatively large number of turns and a relatively large inductance is used and connected to a main board through two contacts; in the case where charging is performed in a PMA mode, an external coil featured with a relatively small number of turns, a relatively small inductance and a small size is used and connected to the main board through two contacts. To avoid interference between the two coils, the two coils are separated by a magnetic isolation material, the total area of the coils is almost in the same level as the width of a rear shell, and the cost is relative high.

In 2016, in the related art, a resonance wireless charging technology WIPOWER is proposed to support A4WP. Compared with Qi and PMA, WIPOWER has the following advantages: the charging range and the user experience are significantly improved, the charging distance is increased from the original 1 cm to more than 10 cm, charging is not limited by the location of mobile phones, and a terminal can be charged without being aligned with a charger. However, because the company proposing the solution and the company achieving the technology are different companies, the charging coil may not be compatible with Qi/PMA and the cost is high. Another important reason is that the charging efficiency of WIPOWER is only 30%, which is very low. The reason for the low efficiency is analyzed as follows: in the case of resonance, the frequency of an LC oscillation circuit drifts and the circuit is in a detuning state. In the case where the frequency of an input signal is equal to a resonance frequency, the LC circuit resonates. In this case, the circuit becomes purely resistive and the efficiency is a maximum. In the case where the frequency of the input signal is greater than the resonance frequency, the LC circuit is in a detuning state, the circuit is inductive, and the inductive impedance is not equal to the inductance of the coil. In the case where the frequency of the input signal is less than the resonance frequency, the LC circuit is in a detuning state and the circuit is capacitive. The inductive circuit and the capacitive circuit are affected by the coil and the resonance capacitor and cannot generate relatively good resonance.

A method embodiment provided by embodiment one of the present application may be executed in a terminal such as a mobile terminal, a computer terminal or other similar computing devices. Using the method to be executed in the mobile terminal as an example, FIG. 2 is a block diagram illustrating the hardware structure of a mobile terminal for a wireless charging method according to an embodiment of the present disclosure. As shown in FIG. 2, a mobile terminal 20 may include one or more (only one is shown in FIG. 2) processors 202 (the processor 202 may include, but is not limited to, a processing device such as a microcontroller unit (MCU) or a field-programmable gate array (FPGA)), a memory 204 configured to store data, and a transmission device 206 with a communication function. It should be understood by those skilled in the art that the structure shown in FIG. 2 is merely illustrative, and not intended to limit the structure of the electronic device described above. For example, the mobile terminal 20 may further include more or fewer components than the components shown in FIG. 2, or may have a configuration different from the configuration shown in FIG. 2.

The memory 204 may be configured to store software programs for application software, as well as modules, such as program instructions or modules corresponding to the wireless charging method in embodiments of the present disclosure. The processor 202 executes the software programs and modules stored in the memory 204 to perform function applications and data processing, that is, to perform the method described above. The memory 204 may include a high-speed random access memory, or may further include a nonvolatile memory such as one or more magnetic storage apparatuses, flash memories or other nonvolatile solid-state memories. In some examples, the memory 204 may further include memories that are remotely disposed with respect to the processors 202. These remote memories may be connected to the mobile terminal 20 via a network. Examples of the preceding network include, but are not limited to, the Internet, an intranet, a local area network, a mobile communication network and combinations thereof.

The transmission apparatus 206 is configured to receive or transmit data via a network. Specific examples of the preceding network may include a radio network provided by a communication provider of the mobile terminal 20. In an example, the transmission apparatus 206 includes a network interface controller (NIC). The NIC may be connected to other network devices via a base station, thereby communicating with the Internet. In an example, the transmission apparatus 206 may be a radio frequency (RF) module, which is configured to communicate with the Internet in a wireless way.

The present embodiment provides a wireless charging method executed on the terminal described above. FIG. 3 is a flowchart of a wireless charging method according to an embodiment of the present disclosure. As shown in FIG. 3, the process includes the steps described below.

In step S302, the charging type of a wireless charger connected to a terminal is determined.

In step S304, the charging mode of the terminal is adjusted to a charging mode matching the charging type of the wireless charger.

In step S306, the terminal is charged by using the wireless charger.

The terminal may perform the preceding operations.

In the embodiment described above, the charging mode of a terminal can be adjusted according to the charging type of a wireless charger so that the purpose of charging a terminal no matter what type of wireless charger is adopted is achieved. In this manner, the following problem is solved: charging fails due to a single charging mode and the mismatch between the charging type of a charger and the charging mode of a terminal in the related art; and thereby the following purpose is achieved: a terminal has more charging modes and thus the terminal can be charged regardless of the charging type of a charger used.

In an optional embodiment, the steps in which the charging type of the wireless charger connected to the terminal is determined includes sending a handshake signal to the wireless charger by using an A4WP communication system in the terminal; and determining the charging type of the wireless charger according to the response state of the wireless charger. In the present embodiment, the A4WP communication system is built into the terminal. The system may have the ability to send a signal to the wireless charger. Therefore, after the A4WP communication system sends a handshake signal to the wireless charger, the charging type of the wireless charger can be determined according to whether the wireless charger makes a response to the handshake signal. In the present embodiment, a handshake signal may be sent to the wireless charger by using other systems satisfying a communication protocol.

In an optional embodiment, the A4WP communication system in the terminal requires power supply to be able to operate normally. How to supply power to the A4WP communication system is described below.

In the case where the battery of the terminal is in a feeding state, power is supplied to the A4WP communication system by using the manner of charging through an energy storage module; and/or, in the case where the battery of the terminal is in a non-feeding state, power is supplied to the A4WP communication system by using the battery of the terminal, or, power is supplied to the A4WP communication system by using the manner of charging through the energy storage module. The manner of charging through the energy storage module includes rectifying, by using a rectifier module in the terminal, an AC electromagnetic inductive signal input by the wireless charger into a DC signal, charging the energy storage module in the terminal by using the DC signal, and supplying power to the A4WP communication system by using the charged energy storage module. It can be known that, in the present embodiment, in the case where the battery of the terminal is in the feeding state, power cannot be supplied to the A4WP communication system by using the battery of the terminal; and in this case, power may be supplied to the A4WP communication system by using the AC electromagnetic inductive signal input by the wireless charger so that the normal operation of the A4WP communication system can also be guaranteed in the case where the battery of the terminal is in the feeding state.

It can be known from the preceding embodiment that the charging type of the wireless charger can be determined according to whether the wireless charger makes a response to the handshake signal. The step in which the charging type of the wireless charger is determined according to the response state of the wireless charger includes one of the following: in the case where it is determined that a response message for the handshake signal returned by the wireless charger is received, determining the charging type of the wireless charger as A4WP; or in the case where it is determined that the response message for the handshake signal returned by the wireless charger is not received, determining the charging type of the wireless charger as Qi or PMA. That is, the wireless charger of a Qi/PMA type does not response to the handshake signal sent by the A4WP communication system and only the wireless charger of an A4WP type responses to the handshake signal sent by the A4WP communication system.

In an optional embodiment, after the charging type of the wireless charger is determined as Qi or PMA, the method further includes turning off the A4WP communication system by outputting an enable signal. In the present embodiment, the terminal can not only support the charging mode of a Qi or PMA type but also support the charging mode of an A4WP type. Because the terminal does not know the type of the charger at the beginning, the main reason for the A4WP communication system to perform handshake is to determine whether the charging type of the charger is an A4WP type, and the A4WP communication system is not actually needed in the case where charging is performed in an Qi and PMA mode. Therefore, after the charging type of the charger is determined as Qi or PMA, to save power, the A4WP communication system may be turned off. Of course, it is to be noted that the A4WP communication system in a Qi or PMA charging mode does not need to be turned off.

From the description of the embodiments described above, it will be apparent to those skilled in the art that the methods in the embodiments described above may be implemented by software plus a necessary general-purpose hardware platform, or may of course be implemented by hardware. However, in many cases, the former is a preferred implementation manner. Based on this understanding, the technical solutions of the present disclosure substantially, or the part contributing to the existing art, may be embodied in the form of a software product. The computer software product is stored in a storage medium (such as a read-only memory (ROM)/random-access memory (RAM), a magnetic disk or an optical disk) and includes several instructions for enabling a terminal device (which may be a mobile phone, a computer, a server, a network device or the like) to perform the method according to each embodiment of the present disclosure.

An embodiment further provides a wireless charging device. The wireless charging device is used for implementing the preceding embodiments and preferred implementations. What has been described will not be repeated. As used below, the term “module” may be software, hardware or a combination thereof capable of implementing predetermined functions. The device in the embodiments described below is preferably implemented by software, but implementation by hardware or by a combination of software and hardware is also possible and conceivable.

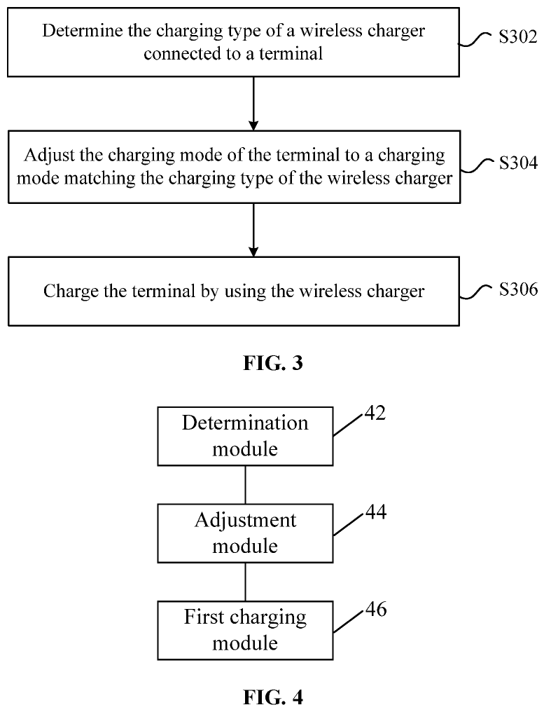

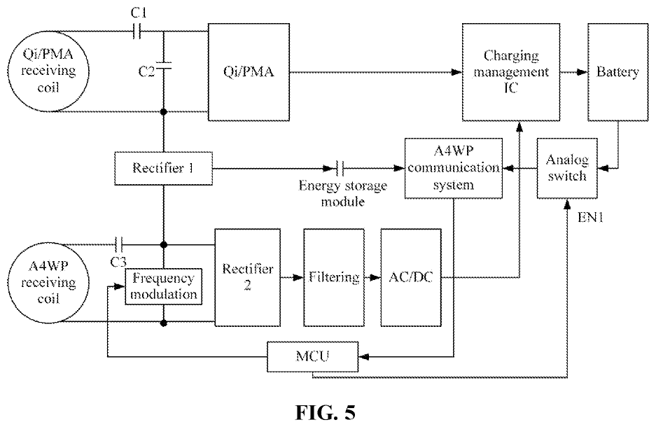

FIG. 4 is a block diagram illustrating the structure of a wireless charging device according to an embodiment of the present disclosure. As shown in FIG. 4, the wireless charging device includes a determination module 42, an adjustment module 44 and a first charging module 46.

The determination module 42 is configured to determine the charging type of a wireless charger connected to a terminal. The adjustment module 44 is connected to the determination module 42 and is configured to adjust the charging mode of the terminal to a charging mode matching the charging type of the wireless charger. The first charging module 46 is connected to the adjustment module 44 and is configured to charge the terminal by using the wireless charger.

In an optional embodiment, the determination module 42 includes a sending unit and a determination unit. The sending unit is configured to send a handshake signal to the wireless charger by using an A4WP communication system in the terminal. The determination unit is configured to determine the charging type of the wireless charger according to the response state of the wireless charger.

In an optional embodiment, the wireless charging device further includes a second charging module, which is configured to, before the charging type of the wireless charger connected to the terminal is determined, perform one of the following: in the case where the battery of the terminal is in a feeding state, supplying power to the A4WP communication system by using the manner of charging through an energy storage module; or in the case where the battery of the terminal is in a non-feeding state, supplying power to the A4WP communication system by using the battery of the terminal or by using the manner of charging through the energy storage module; where the manner of charging through the energy storage module includes rectifying, by using a rectifier module in the terminal, an AC electromagnetic inductive signal input by the wireless charger into a DC signal, charging the energy storage module in the terminal by using the DC signal, and supplying power to the A4WP communication system by using the charged energy storage module.

In an optional embodiment, the determination unit may determine the charging type of the wireless charger in at least one of the following manners: in the case where it is determined that a response message for the handshake signal returned by the wireless charger is received, determining the charging type of the wireless charger as A4WP; or in the case where it is determined that the response message for the handshake signal returned by the wireless charger is not received, determining the charging type of the wireless charger as Qi or PMA.

In an optional embodiment, after the charging type of the wireless charger is determined as Qi or PMA, the adjustment module is configured to turn off the A4WP communication system by outputting an enable signal.

In the present embodiment, a wireless charger terminal is further provided. The wirelessly chargeable terminal will be described in detail as below.

In an optional embodiment, the wirelessly chargeable terminal includes an A4WP communication system (corresponding to the determination module 42) and a controller (corresponding to the adjustment module 44 and the second charging module). The A4WP communication system is configured to determine the charging type of a wireless charger. The controller is connected to the A4WP communication system and is configured to adjust, according to the charging type of the wireless charger, the charging mode of the terminal to a charging mode matching the charging type of the wireless charger.

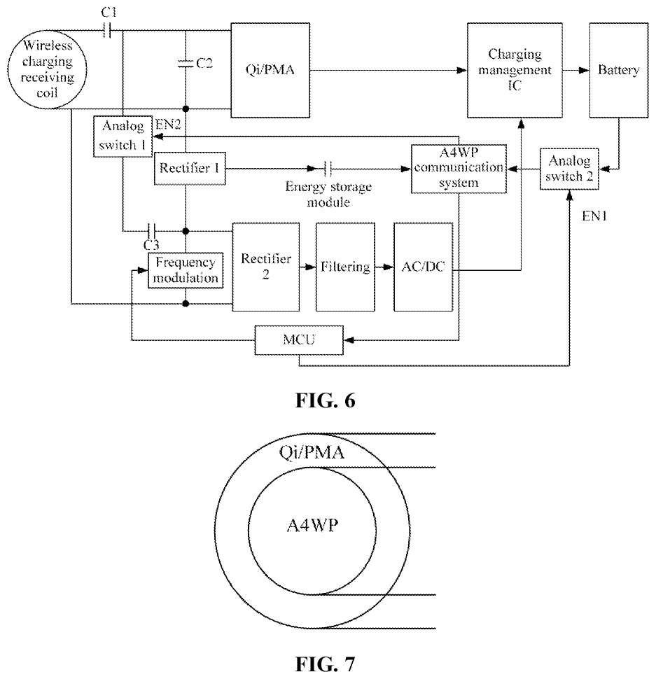

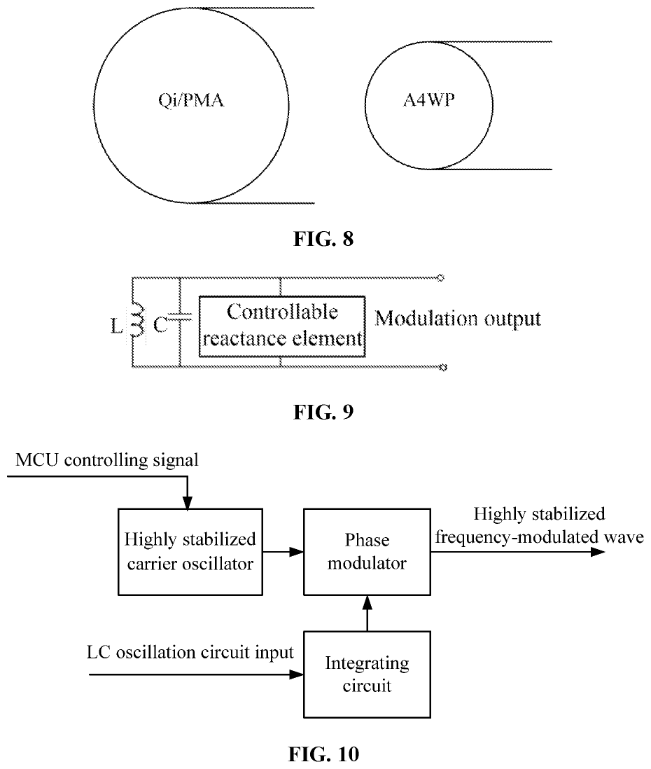

In an optional embodiment, the wirelessly chargeable terminal further includes a wireless charging receiving coil, a charging processing module (corresponding to the first charging module 46) and a charging management IC. The wireless charging receiving coil is connected to the wireless charger and is configured to receive an AC electromagnetic inductive signal input by the wireless charger. The charging processing module is connected to the wireless charging receiving coil and is configured to convert the AC electromagnetic inductive signal to a DC voltage signal. The charging management IC is connected to the charging processing module and is configured to charge the battery of the wirelessly chargeable terminal by using the DC voltage signal. In the present embodiment, the number of the wireless charging receiving coils may be one or may be multiple. In the case where only one wireless charging receiving coil is provided (referring to FIG. 6), the same coil is adopted in multiple charging modes. In the case where multiple wireless charging receiving coils are provided, each coil is adopted in a respective charging mode. For example, in the case where two wireless charging receiving coils are provided (referring to FIG. 5), one of the two coils may be adopted as the coil in a Qi/PMA charging mode and the other one of the two coils may be adopted as the coil in an A4WP charging mode. The processor may be a microcontroller unit (MCU) or may be designed as another type of processor according to actual conditions and the MCU module is an entire terminal processor, where the function here is to determine whether to enable a frequency modulation module according to a current charging type. In the case where charging is performed in the A4WP mode, the MCU outputs high level/low level through GPIO to enable the frequency modulation module. In the present embodiment, the charging mode of a terminal can be adjusted according to the charging type of a wireless charger so that the purpose of charging a terminal no matter what type of wireless charger is adopted is achieved. In this manner, the following problem is solved: charging fails due to a single charging mode and the mismatch between the charging type of a charger and the charging mode of a terminal in the related art; and thereby the following purpose is achieved: a terminal has more charging modes and thus the terminal can be charged regardless of the charging type of a charger used. In the present embodiment, the receiving coil is wound by copper wires or FPC and coupled with a charging mount to receive high-frequency electromagnetic waves generated by the wireless charging mount. As shown in FIG. 7 and FIG. 8. FIG. 7 is a two-in-one receiving coil. A Qi/PMA receiving coil and an A4WP receiving coil may both be located on a rear shell of the terminal (or other positions) and the two coils are separated. The A4WP coil may be located inside/outside the Qi/PMA coil. FIG. 8 is separated receiving coils. The Qi/PMA coil is located on the rear shell of the terminal (of course, may be located in other positions) and the A4WP coil may be located in any position of a mobile phone. The A4WP communication system may adopt an independent communication manner, perform communication beyond Bluetooth Low Energy (a frequency range of 2.4 GHz), and is mainly used in data exchange between a receiving end and a charger. The data exchange includes sending a handshake signal when charging is started, ending charging and how much power should be sent. In embodiments of the present disclosure, a power supply manner of the A4WP communication system adopts two manners. In the case where the battery is in a fully-feeding state, an AC electromagnetic inductive signal is rectified at the beginning, a DC signal generated by the rectification charges an energy storage module and the energy storage module supplies power to the communication system. In the case where the battery has power, power supply may be performed by the battery of the system or completely using the solution in the case where the battery is in the feeding state. In the case where power is supplied by using the battery, an enable signal may be sent through the MCU to enable an analog switch to control the connection and disconnection.

In an optional embodiment, the charging processing module may include a first rectifier module and an energy storage module. The first rectifier module is connected to the energy storage module and is configured to rectify the AC electromagnetic inductive signal input by the wireless charger into the DC signal and charge the energy storage module by using the DC signal. The energy storage module is connected to the A4WP communication system and is configured to supply power to the A4WP communication system by using stored energy. In the present embodiment, the purpose that power is supplied to the A4WP communication system by using the AC electromagnetic inductive signal input by the wireless charger is achieved and thereby the purpose of the normal operation of the A4WP communication system even in the case where the battery of the terminal is in the feeding state is achieved. That is, the function of the energy storage module here is described as follows: in the startup phase of wireless charging, that is, in the case where the terminal is just placed on the charger, an LC oscillation loop starts to work in this case; to ensure that the working stability of the LC oscillation loop in a short time, the energy storage module provides the LC oscillation loop with a stable load for a short time; and the LC oscillation loop is placed in a no-load operation and quickly stops while a capacitor/inductance with a relatively large capacitance may be chose for the energy storage module. The first rectifier module is configured to convert the AC electromagnetic inductive signal to the DC signal.

It can be known from the preceding embodiments that the terminal supports multiple charging modes. In the present embodiment, the charging processing module further includes a first charging module corresponding to a charging mode Qi/PMA and a second charging module corresponding to a charging mode A4WP. The first charging module and the second charging module are described below.

As shown in FIG. 5 (reference may also be made to FIG. 6; in the present embodiment, FIG. 5 is used as an example for description), the first charging module includes a first capacitor (that is, C1), a second capacitor (that is, C2) and a Qi/PMA wireless charging conversion unit (that is, Qi/PMA). The first capacitor is connected to the wireless charging receiving coil and the Qi/PMA wireless charging conversion unit, the second capacitor is connected to the first capacitor, the Qi/PMA wireless charging conversion unit and a first rectifier module, and the Qi/PMA wireless charging conversion unit is connected to the IC. The second charging module includes a third capacitor (that is, C3), a frequency modulation module, a second rectifier module (that is, rectification 2), a filter module and a buck module (that is, a DC/DC module or a low dropout regulator (LDO) module). The third capacitor is connected to the wireless charging receiving coil and the first rectifier module, the frequency modulation module is connected to the third capacitor, the first rectifier module and the controller, the second rectifier module is connected to the wireless charging receiving coil, the frequency modulation module, the first rectifier module and the filter module, the filter module is connected to the buck module, and the buck module is connected to the IC. In the present embodiment, the Qi/PMA wireless charging conversion unit is configured to convert the received wireless charging signal with a frequency of 100-205 KHz or a frequency of 277-357 KHz to a DC voltage signal. The charging management IC is configured to receive the DC signal output by the wireless charging terminal and charge the battery of the terminal. The capacitor C1 and the capacitor C2 are Qi/PMA wireless charging matching capacitors. C1 and C2 are not unique and may be multiple capacitors which are connected in series or in parallel. The capacitance of C1 and the capacitance of C2 may be calculated according to a Qi/PMA standard calculation method. The capacitor C3 is an A4WP wireless charging matching capacitor. C3 is not unique and may be multiple capacitors which are connected in series or in parallel. C3 may be calculated according to the formula 1, where fr=6.78 MHz and L denotes a coil inductance. The frequency modulation module is configured to adjust the resonance frequency of the entire LC oscillation circuit to a fixed frequency of 6.78 MHz in the case where charging is performed in the A4WP mode, and the frequencies, the phases and the signals generated by the transmitting end are the same so that the entire LC oscillation circuit is in a resonance state rather than a detuning state. The frequency modulation module may adopt direct frequency modulation, as shown in FIG. 9, a controllable reactance element is a gate network composed of adjustable capacitors or multiple capacitors connected in parallel; the frequency modulation module may adopt indirect frequency modulation, as shown in FIG. 10, such as a voltage-controlled oscillator. Any frequency modulation manner adopted here to achieve resonance with a fixed frequency of 6.78 MHz falls within the scope of embodiments of the present disclosure. The filter module is configured to filter the rectified DC signal. The LDO is configured to convert the rectified DC signal to a DC signal required by the charging management IC. The frequency modulation module is configured to generate ideal sinusoidal waves.

In an optional embodiment, in the case where only one wireless charging receiving coil is provided, the wirelessly chargeable terminal further includes a first analog switch (an analog switch 1 in FIG. 6), where the first analog switch is connected to the first capacitor, the second capacitor, the third capacitor and the A4WP communication system and is configured to control a charging mode corresponding to the wireless charging receiving coil. In the present disclosure, if a three-in-one wireless charging receiving coil is adopted, as shown in FIG. 6, an analog switch needs to be added between the A4WP and the matching capacitor C3. In the case where charging is performed in the A4WP mode, the A4WP communication system or other module outputs an enable signal EN2 to enable the analog switch. In this case, to obtain a three-in-one coil and reduce the cost of the coil, the inductance of the coil is fixed at the beginning and the inductance required by the Qi/PMA is greater than the inductance required by the A4WP. Therefore, the matching capacitor C3 is less than C1 and C2 and the inductance of C3 needs to be more accurate. To obtain a more accurate capacitor, the matching capacitor C3 may be multiple capacitors connected in series.

In an optional embodiment, the wirelessly chargeable terminal further includes a second analog switch (such as analog switch 2 in FIG. 6 and the analog switch in FIG. 5), where the second analog switch is connected to the controller, the A4WP communication system and the battery and is configured to control connection and disconnection between the battery and the A4WP communication system.

A charging process in embodiments of the present disclosure will be described with reference to drawings.

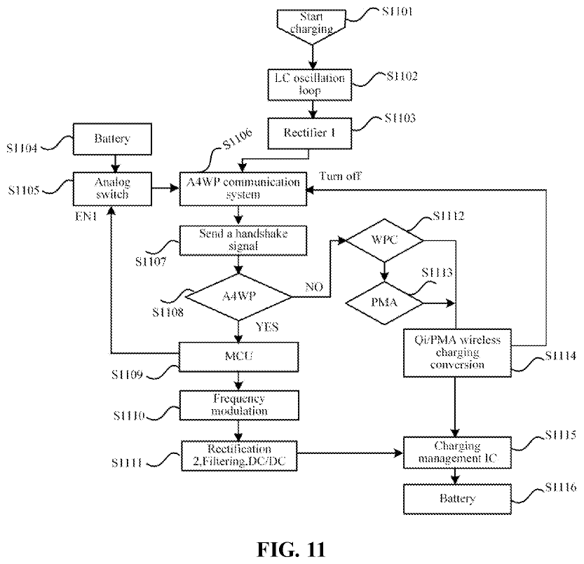

In embodiments of the present disclosure, a three-mode wireless charging method is provided. Referring to FIG. 11, the steps of switching between three types of wireless charging are described below.

1. In a default state, the present disclosure is in a Qi/PMA charging mode. It is mainly considered that the current mainstream market supports these two charging modes.

2. When the wireless charging operation (corresponding to step S1101 in FIG. 11) is performed, at the beginning, an LC oscillation loop generates a high-voltage signal (corresponding to step S1102) and supplies power to an A4WP communication system through rectifier 1 (corresponding to step S1103 and step S1106). The A4WP communication system sends a handshake signal to a transmitting end (corresponding to step S1107) and performs a determination operation to determine whether the charger is of the A4WP type (corresponding to step S1108). If the transmitting end receives the handshake signal and makes a response, the charger is of the A4WP type (going to step S1109, executing the subsequent processing of a terminal processor MCU making a response, completing frequency modulation, rectification, filtering, buck processing, and charging a battery by a charging management IC (corresponding to steps S1109 to S1111 and steps S1115 to S1116)). Otherwise, the charger may be of a Qi/PMA type (going to step S1112, firstly whether the charger is of the Qi type (that is, WPC) or of the PMA type is determined; and after the type of the charger is determined, an AC is converted to a DC by a Qi/PMA wireless charging conversion unit and the battery is charged by the charging management IC through the DC (corresponding to steps S1112 to S1116)). Moreover, power may be supplied to the A4WP communication system by using the battery in the terminal. During power supply, the connection and disconnection between the battery and the A4WP communication system may be controlled by an analog switch, where the analog switch may be controlled by the MCU through EN1 (corresponding to S1104 and S1105).

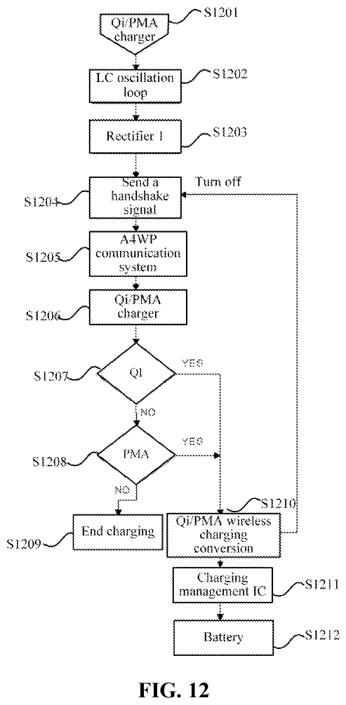

3. If the current charger is a Qi/PMA standard charger (corresponding to step S1201 in FIG. 12), the specific operations are shown in FIG. 12. The power is generated by the LC oscillation loop (corresponding to step S1202) and is supplied to the A4WP communication system through a rectifier 1 (corresponding to steps S1203 to S1204). The A4WP communication system sends the handshake signal to the charger (corresponding to step S1205). Because the charger is the Qi/PMA standard charger, the charger does not make a response to the handshake signal. The charging operation performed by the Qi/PMA charger does not be ended because of the handshake signal (corresponding to step S1206). The Qi/PMA standard charger performs determination of charging type of Qi or PMA (corresponding to steps S1207 to S1208). If one charging type is met, charging is performed in the corresponding standard and an enable signal is output to turn off the A4WP communication system (corresponding to steps S1210 to S1212). Otherwise, charging is ended (corresponding to step S1209).

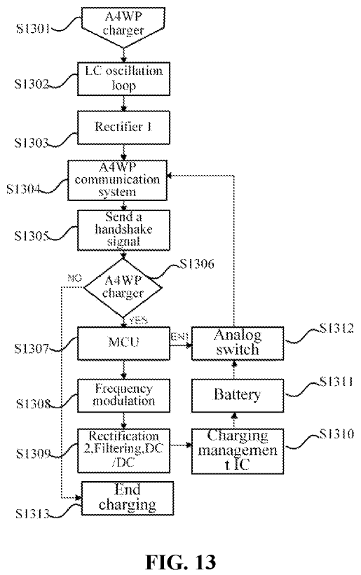

4. If the current charger is an A4WP standard charger (corresponding to step S1301 in FIG. 13), the charging process is shown in FIG. 13. In the case where the voltage of the battery of the terminal is lower than the minimum voltage for the system startup, the charging mode of the system is pre-charging mode or trickle charging mode. In this case, the MCU cannot start up, and frequency modulation is not performed. In the case where the voltage of the battery is greater than the minimum voltage for the system startup, the system enters a power-off charging mode and the MCU enables a frequency modulation module to adjust the resonance frequency of the LC oscillation loop (corresponding to step S1302) so that the LC oscillation loop works in a frequency below the standard frequency of 6.78 MHz. An AC sinusoidal electromagnetic inductive signal generated by the A4WP charger is converted into a DC signal required by the system through a rectifier, filtering circuit and a DC/DC circuit. The DC signal charges the battery (in this process, the A4WP communication system also sends the handshake signal to the transmitting end, that is, the charger, to determine whether the charging type of the charger is A4WP; if the charging type of the charger is A4WP, the MCU performs frequency modulation, rectification, filtering and buck DC-DC processing and the charging management IC supplies power to the battery (corresponding to steps S1304 to S1311); if the charging type of the charger is not A4WP, charging is ended (corresponding to step S1313)). In the case where the system starts up or the battery has power, if the power supply manner of the A4WP communication system is power supply performed by the battery, then the analog switch is enabled through EN1 (corresponding to step S1312).

It is to be noted that the preceding modules may be implemented by software or hardware. Implementation by hardware may, but may not necessarily, be performed in the following manner: the preceding modules are located in the same processor or the preceding modules are located in any combination in their respective processors.

An embodiment of the present disclosure further provides a storage medium. The storage medium includes a stored program. When the program is executed, the method of any one of the preceding embodiments is performed.

Optionally, in the present embodiment, the storage medium may include, but is not limited to, a U disk, a read-only memory (ROM), a random-access memory (RAM), a mobile hard disk, a magnetic disk, an optical disk or various other media capable of storing program codes.

An embodiment of the present disclosure further provides an electronic device that includes a memory, a processor, and a computer program stored in the memory and executable by the processor. The processor is configured to perform the steps in any one of the preceding methods through the computer program.

It can be known from the preceding embodiments that the present disclosure achieves the adaptive matching of the frequency of the LC oscillation loop through frequency modulation. The significant difference between A4WP and Qi/PMA is that A4WP uses resonance mode to perform charging and the electromagnetic induction frequency of A4WP is significantly different from the electromagnetic induction frequency of Qi/PMA. The natural frequency of A4WP is 6.78 MHz while the natural frequency of Qi is 100-205 KHz and the natural frequency of PMA is 277-357 KHz. Moreover, the frequency is changeable during charging. Therefore, charging cannot be performed if the same LC oscillation circuit is used in the A4WP charger. Compared with the existing art, the present disclosure has the advantages below.

1. Common-mode wireless charging of the three modes of Qi, PMA and A4WP is achieved. Compared with the traditional single-mode wireless charging, the common-mode wireless charging of the three modes of Qi, PMA and A4WP has a more flexible charging manner and supports A4WP wireless charging. A mobile phone does not need to be completely aligned with a charging coil so that a charging distance is increased and the user experience is improved.

2. A wireless charging mode to which a mobile phone is adapted currently can be detected and converted so that the efficiency is maximized.

3. The power supply of an A4WP wireless charging communication system in the case where a battery is in a feeding state is achieved. Compared with the existing solution, A4WP charging can be performed in the case where a terminal is turned off or is in a full-feeding state.

4. In the present disclosure, an LC oscillation frequency is changed through external excitation so that when A4WP charging is performed, the frequency of a transmitting end and the frequency of a receiving end are identical, resonance is generated, the perfect match between the transmitting end and the receiving end in the resonance mode is achieved, and the charging efficiency is improved.

Moreover, the terminal in embodiments of the present disclosure can be charged by all wireless chargers currently in the market. Compared with the existing art, the present disclosure significantly reduces the costs. The problem of low efficiency of A4WP resonance wireless charging is solved through frequency adjustment.

Apparently, it is to be understood by those skilled in the art that the modules or steps of the present disclosure may be implemented by at least one generic computing device and may be concentrated on a single computing device or distributed in a network formed by multiple computing devices. Optionally, these modules or steps may be implemented by program codes executable by the at least one computing device. Thus, these modules or steps may be stored in a storage medium and executed by the at least one computing device. Moreover, in some cases, the illustrated or described steps may be executed in a sequence different from the sequence described herein. Alternatively, each of these modules or steps may be implemented by being made into an integrated circuit module or multiple ones of these modules or steps may be implemented by being made into a single integrated circuit module. In this manner, the present disclosure is not limited to any specific combination of hardware and software.

The above are merely preferred embodiments of the present disclosure and are not intended to limit the present disclosure. Those skilled in the art can make various modifications and changes. Any modifications, equivalent substitutions, improvements and the like made within the principle of the present disclosure should fall within the scope of the present disclosure.

### INDUSTRIAL APPLICABILITY

As described above, a wireless charging method and device, a terminal, a storage medium and an electronic device provided by embodiments of the present disclosure have the following beneficial effects. The following problem is solved: charging fails due to a single charging mode and the mismatch between the charging type of a charger and the charging mode of a terminal in the related art. The following purpose is achieved: a terminal has more charging modes and thus the terminal can be charged regardless of the charging type of a charger used.

1. A wireless charging method, comprising:
determining a charging type of a wireless charger connected to a terminal;
adjusting a charging mode of the terminal to a charging mode matching the charging type of the wireless charger; and
charging the terminal by using the wireless charger.

2. The wireless charging method of claim 1, wherein determining the charging type of the wireless charger connected to the terminal comprises:
sending a handshake signal to the wireless charger by using an A4WP communication system in the terminal; and
determining the charging type of the wireless charger according to a response state of the wireless charger.

3. The wireless charging method of claim 2, wherein before determining the charging type of the wireless charger connected to the terminal, the method further comprises one of the following:
in response to a battery of the terminal being in a feeding state, supplying power to the A4WP communication system by using a manner of charging through an energy storage module; or
in response to the battery of the terminal being in a non-feeding state, supplying power to the A4WP communication system by using the battery of the terminal or by using the manner of charging through the energy storage module,
wherein the manner of charging through the energy storage module comprises:
rectifying, by using a rectifier module in the terminal, an alternating-current electromagnetic inductive signal input by the wireless charger into a direct-current signal;
charging the energy storage module in the terminal by using the direct-current signal; and
supplying power to the A4WP communication system by using the charged energy storage module.

4. The wireless charging method of claim 2, wherein determining the charging type of the wireless charger according to the response state of the wireless charger comprises one of the following:
in response to determining that a response message for the handshake signal returned by the wireless charger is received, determining the charging type of the wireless charger as A4WP; or
in response to determining that the response message for the handshake signal returned by the wireless charger is not received, determining the charging type of the wireless charger as Qi or PMA.

5. The wireless charging method of claim 2, wherein after determining the charging type of the wireless charger as Qi or PMA, the method further comprises:
turning off the A4WP communication system by outputting an enable signal.

6. A wireless charging device, comprising a processor and a memory for storing execution instructions that when executed by the processor cause the processor to perform steps in following modules:
a determination module, which is configured to determine a charging type of a wireless charger connected to a terminal;
an adjustment module, which is configured to adjust a charging mode of the terminal to a charging mode matching the charging type of the wireless charger; and
a first charging module, which is configured to charge the terminal by using the wireless charger.

7. The wireless charging device of claim 6, wherein the determination module comprises:
a sending unit, which is configured to send a handshake signal to the wireless charger by using an A4WP communication system in the terminal; and
a determination unit, which is configured to determine the charging type of the wireless charger according to a response state of the wireless charger.

8. The wireless charging device of claim 7, further comprising a second charging module, which is configured to, before the charging type of the wireless charger connected to the terminal is determined, perform one of the following:
in response to a battery of the terminal being in a feeding state, supplying power to the A4WP communication system by using a manner of charging through an energy storage module; or
in response to the battery of the terminal being in a non-feeding state, supplying power to the A4WP communication system by using the battery of the terminal or by using the manner of charging through the energy storage module,
wherein the manner of charging through the energy storage module comprises rectifying, by using a rectifier module in the terminal, an alternating-current electromagnetic inductive signal input by the wireless charger into a direct-current signal, charging the energy storage module in the terminal by using the direct-current signal, and supplying power to the A4WP communication system by using the charged energy storage module.

9. A wirelessly chargeable terminal, comprising an A4WP communication system and a controller, wherein
the A4WP communication system is configured to determine a charging type of a wireless charger connected to the wirelessly chargeable terminal; and
the controller is connected to the A4WP communication system and is configured to adjust, according to the charging type of the wireless charger, a charging mode of the wirelessly chargeable terminal to a charging mode matching the charging type of the wireless charger.

10. The wirelessly chargeable terminal of claim 9, further comprising a wireless charging receiving coil, a charging processing module and a charging management Integrated Circuit (IC), wherein
the wireless charging receiving coil is connected to the wireless charger and is configured to receive an alternating-current electromagnetic inductive signal input by the wireless charger;
the charging processing module is connected to the wireless charging receiving coil and is configured to convert the alternating-current electromagnetic inductive signal into a direct-current voltage signal; and
the charging management IC is connected to the charging processing module and is configured to charge a battery of the wirelessly chargeable terminal by using the direct-current voltage signal.

11. The wirelessly chargeable terminal of claim 10, wherein the charging processing module comprises a first rectifier module and an energy storage module, wherein
the first rectifier module is connected to the energy storage module and is configured to rectify the alternating-current electromagnetic inductive signal input by the wireless charger into the direct-current signal and charge the energy storage module by using the direct-current signal; and
the energy storage module is connected to the A4WP communication system and is configured to supply power to the A4WP communication system by using energy stored in the energy storage module.

12. The wirelessly chargeable terminal of claim 11, wherein the charging processing module further comprises a first charging module corresponding to a charging mode Qi/PMA, wherein
the first charging module comprises a first capacitor, a second capacitor and a Qi/PMA wireless charging conversion unit, wherein
the first capacitor is connected to the wireless charging receiving coil and the Qi/PMA wireless charging conversion unit,
the second capacitor is connected to the first capacitor, the Qi/PMA wireless charging conversion unit and the first rectifier module, and
the Qi/PMA wireless charging conversion unit is connected to the charging management IC.

13. The wirelessly chargeable terminal of claim 12, wherein the charging processing module further comprises a second charging module corresponding to a charging mode A4WP, wherein
the second charging module comprises a third capacitor, a frequency modulation module, a second rectifier module, a filter module and a buck module, wherein
the third capacitor is connected to the wireless charging receiving coil and the first rectifier module,
the frequency modulation module is connected to the third capacitor, the first rectifier module and the controller,
the second rectifier module is connected to the wireless charging receiving coil, the frequency modulation module, the first rectifier module and the filter module,
the filter module is connected to the buck module, and
the buck module is connected to the charging management IC.

14. The wirelessly chargeable terminal of claim 13, wherein in response to only one wireless charging receiving coil being provided, the wirelessly chargeable terminal further comprises a first analog switch, wherein the first analog switch is connected to the first capacitor, the second capacitor, the third capacitor and the A4WP communication system and is configured to control a charging mode corresponding to the wireless charging receiving coil.

15. The wirelessly chargeable terminal of claim 10, further comprising a second analog switch, wherein
the second analog switch is connected to the controller, the A4WP communication system and the battery and is configured to control connection and disconnection between the battery and the A4WP communication system.

16. A non-transitory storage medium, comprising a stored program, wherein the method of claim 1 is performed when the program is executed.

17. An electronic device, comprising a memory, a processor, and a computer program stored in the memory and executable on the processor, wherein the processor is configured to perform the method of claim 1 through the computer program.
